(19) United States
(12) Patent Application Publication
(10) Pub. No.: US 2026/0052392 A1
(43) Pub. Date: Feb. 19, 2026

(54) LAWFUL INTERCEPT PROVISIONING SYSTEM

(71) Applicant: Verizon Patent and Licensing Inc., Basking Ridge, NJ (US)

(72) Inventors: Amir Saghir, Frisco, TX (US); William W. Wong, Madison, NJ (US); Jayshree A. Bharatia, Plano, TX (US); Michael Chen, Pittstown, NJ (US)

(21) Appl. No.: 18/807,378

(22) Filed: Aug. 16, 2024

(51) Int. Cl. H04W 12/80

(52) U.S. Cl. CPC H04W 12/80

(57) ABSTRACT

A method, a device, and a non-transitory storage medium are described in which lawful intercept service is provided. The lawful intercept service may include transmitting information regarding one or more user plane functions (UPFs) or content of communication (CC) point of intercept (POI) aggregators (CC-PAGs) that have been updated or instantiated on a telecommunications network to an administrative function of a lawful intercept system in the telecommunications network; and automatically provisioning, in response to the informing, each UPF associated with the administrative function regarding identities of available CC-PAGs and selection criteria for determining when to forward intercepted CC to particular ones of the available CC-PAGs.

### BACKGROUND

Mobile networks support lawful intercept (LI) of communications made via the networks. For example, in response to a lawful warrant or request, mobile networks may identify and forward appropriate data, voice, and other communications to a law enforcement agency associated with the warrant or request.

### BRIEF DESCRIPTION OF THE DRAWINGS

FIG. 1 is a diagram illustrating an exemplary environment in which systems and methods described herein may be implemented;

FIG. 2 is a block diagram illustrating a lawful intercept system consistent with implementations described herein;

FIG. 3 is a block diagram illustrating an exemplary environment consistent with implementations described herein;

FIG. 4 is a diagram illustrating exemplary components of a device that may correspond to one or more devices illustrated and described herein;

FIG. 5 is a flow diagram illustrating an exemplary process associated with provisioning or updating a lawful intercept system consistent with implementations described herein; and

FIG. 6 is a call flow diagram illustrating exemplary signal flows associated with provisioning or updating a lawful intercept system.

### DETAILED DESCRIPTION OF EXAMPLE EMBODIMENTS

The following detailed description refers to the accompanying drawings. The same reference numbers in different drawings may identify the same or similar elements. The following detailed description does not limit the invention as claimed.

Embodiments described herein relate to systems and methods for provisioning and implementing lawful intercept components and processing within a communications network. A lawful intercept system includes various components that support lawful interception by a law enforcement agency (LEA), including lawful intercept-specific devices or network functions (NFs). One such device is a point of interception (POI) network function that collects data from a User Equipment (UE) device (e.g., smart phone) and forwards the data to a mediation and delivery function (MDF) (e.g., MDF3), which ultimately delivers the intercepted data to an LEA. Although the description provided herein refers to network functions, in various embodiments, such network functions may be implemented using virtual or physical devices.

In general, a provisioning function such as a lawful interception provisioning function (LIPF) provisions a POI and associates the POI with one or more UE devices. However, maintaining network connections between each POI and corresponding MDFs can overutilize network resources. Thus, some LI systems include aggregation devices. One example of an aggregation device is a POI aggregator (PAG or content of communication (CC)-PAG). A CC-PAG is a network function located between one or more CC-POIs and the MDF.

Consistent with embodiments described herein, a LIPF may introduce or update the relationship between CC-POIs and CC-PAGs based on a number of instantiated CC-PAGs and selection criteria to be used when selecting a particular CC-PAG or forward CC directly to the MDF. In particular, as described below, the LIPF may provision each user plane function (UPF) in a mobile network with information regarding the identities of and selection criteria associated with the available CC-PAGs.

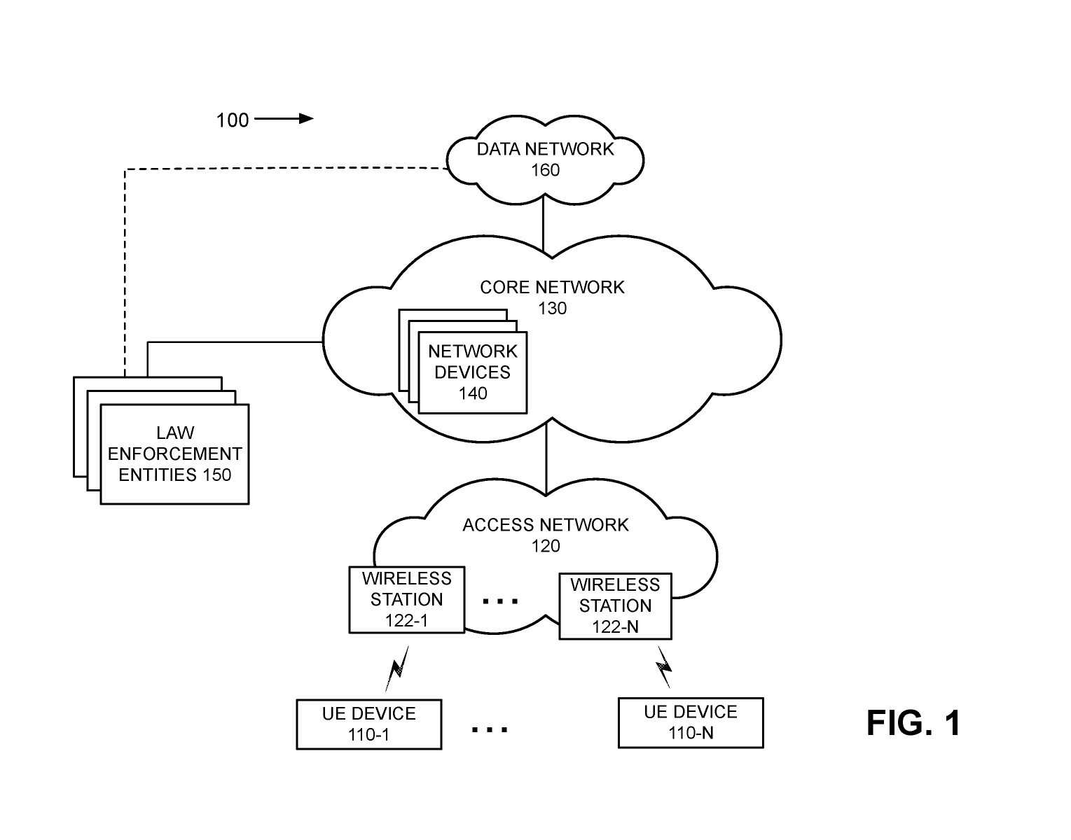

FIG. 1 is a diagram illustrating an exemplary environment 100 in which systems and methods described herein may be implemented. Referring to FIG. 1, environment 100 includes UE devices 110-1 through 110-N, access network 120, wireless stations 122-1 through 122-N, core network 130, network devices 140, law enforcement entities 150, and data network 160.

UE devices 110-1 through 110-N (referred to herein individually as UE device or UE 110, and collectively as UE devices or UEs 110) may include any computing device, such as a personal computer (PC), a laptop computer, a server, a tablet computer, a notebook, a Chromebook®, a mobile device, such as wireless or cellular telephone device (e.g., a conventional cell phone with data processing capabilities), a smart phone, a personal digital assistant (PDA) that can include a radiotelephone, any type of mobile computer device or system, a game playing device, a wearable device, such as a smart watch, smart ring, bodycam, etc., a vehicle-based device, such as a vehicle telematics system, dashcam, etc. a music playing device, a home appliance device, a home monitoring device, a virtualized system, an Internet of Things (IoT) device, a machine type communication (MTC) device, etc., that includes communication functionality. UE device 110-1 may connect to access network 120 via wireless station 122-1 and UE device 110-N may connect to access network 120 via wireless station 122-N. UE devices 110 may also connect to other devices in environment 100 via other techniques, such as wired, wireless, optical connections or a combination of these techniques. UE device 110 and a person that may be associated with UE device 110 (e.g., the party holding or using UE device 110) may be referred to collectively as UE device 110 or UE 110 in the description below.

Access network 120 may provide access to core network 130 for wireless devices, such as UE devices 110. Access network 120 may enable UE device 110 to connect to core network 130 for Internet access, non-Internet Protocol (IP) data delivery, cloud computing, mobile telephone service, Short Message Service (SMS), Multimedia Message Service (MMS), and/or other types of data services. Access network 120 may provide access to core network 130, a service or application layer network, a cloud network, a multi-access edge computing (MEC) network, a fog network, etc. Furthermore, access network 120 may enable a device in core network 130 to signal UE device 110 using a non-IP message delivery method such as Data over Non-Access Stratum (DoNAS).

Consistent with implementations described herein, access network 120 may include a Fifth Generation (5G) access network or another advanced network. For example, access network 120 may include the functionality of a 5G network, such as 5G Radio Access Network (RAN) communicating via mmWave technology, a 5G RAN communicating via C-band technology or other types of 5G networks. Access network 120 may also include a 4G RAN. In still other implementations, access network 120 may include a non-terrestrial network (NTN), such as a satellite-based network.

Access network 120 may also include: support for massive multiple-input and multiple-output (MIMO) antenna configurations (e.g., an 8x8 antenna configuration, a 16x16 antenna configuration, a 256x256 antenna configuration, etc.); support for cooperative MIMO (CO-MIMO) configurations; support for carrier aggregation; relay stations; Heterogeneous Networks (HetNets) of overlapping small cells and macrocells; Self-Organizing Network (SON) functionality; machine type communication (MTC) functionality, such as 1.4 MHz wide enhanced MTC (eMTC) channels (also referred to as category Cat-M1), Low Power Wide Area (LPWA) technology such as Narrow Band (NB) IoT (NB-IoT) technology, and/or other types of MTC technology; and/or other types of 5G functionality.

Wireless stations 122-1 through 122-N (referred to collectively as wireless stations 122 and individually as wireless station 122) may be included in access network 120. Each wireless station 122 may service a number of UE devices 110 when the particular UE device 110 is within the range of wireless station 122. In one implementation, wireless station 122 may include 5G base station (e.g., a next generation NodeB (gNB)) that includes one or more radio frequency (RF) transceivers. For example, wireless station 122 may include three RF transceivers and each RF transceiver may service a 120 degree sector of a 360 degree field of view. Each RF transceiver may include or be coupled to an antenna array. The antenna array may include an array of controllable antenna elements configured to send and receive 5G new radio (NR) wireless signals via one or more antenna beams. In other implementations, wireless station 122 may also include a 4G base station (e.g., an evolved NodeB (eNodeB)) or a 6G base station that communicates wirelessly with UEs 110. In implementations incorporating non-terrestrial networks, wireless stations 122 may include one or more satellites that receive information from UE devices 110.

Core network 130 may include one or more wired, wireless and/or optical networks that are capable of receiving and transmitting data, voice and/or video signals. In an exemplary implementation, core network 130 (and access network 120) may be associated with a telecommunications service provider (e.g., a cellular wireless communication service provider and/or wired communication service provider) and may manage communication sessions of UE devices 110 connecting to core network 130 via access network 120. Core network 130 may include one or multiple networks of different types and technologies. For example, core network 130 may be implemented to include a next generation core (NGC) network for a 5G network, an Evolved Packet Core (EPC) of a Long-Term-Evolution (LTE) or LTE Advanced network, a sixth generation (6G) network, and/or a legacy core network. Core network 130 may provide packet-switched services and wireless IP connectivity to various components in environment 100, such as UE devices 110, to provide, for example, data, voice, and/or multimedia services.

Core network 130 may include various network devices 140 to support its operation in a manner consistent with one or more network types or technologies. For example, network devices 140 may include 5G core network components (e.g., a User Plane Function (UPF), an Access and Mobility Management Function (AMF), a Session Management Function (SMF), a Unified Data Management (UDM) function, a Unified Data Repository (UDR), a Policy Control Function (PCF), a Charging Function (CHF), a network exposure function (NEF), an application function (AF), etc.), 4G core network components (e.g., a Serving Gateway (SGW), a Packet data network Gateway (PGW), a Mobility Management Entity (MME), a Home Subscriber Server (HSS), a Policy Charging and Rules Function (PCRF) etc.), or another type of core network components (e.g., future 6G network components).

Furthermore, consistent with embodiments described herein, core network 130 may include network devices 140 configured to support lawful intercept of user communications and related information. For example, as described in detail below, core network 130 may include an administrative and management function (ADMF), a plurality of Point(s) Of Interception (POIs), a plurality of Triggering Functions (TFs) and/or triggered functions (e.g., triggered by the 5G SMF), and one or more Mediation and Delivery Functions (MDFs). Collectively, network devices 140 enable, upon request from a law enforcement entity 150, interception and forwarding of specific user-related information to the law enforcement entity 150.

As described herein, law enforcement entities 150 include network devices associated with any of a variety of law enforcement agencies authorized to transmit warrant or other types of lawful intercept request information to the telecommunications service provider that operates core network 130. Although not described in detail herein, law enforcement entities 150 may be configured to communicate with one or more network devices 140 via particular secure interfaces, such as LI_HI1, LI_HIQR, LI_HILA interfaces.

Data network 160 may include, for example, a packet data network. In an exemplary implementation, UE device 110 may connect to data network 160 via core network 130. Data network 160 may also include and/or be connected to a local area network (LAN), a wide area network (WAN), a metropolitan area network (MAN), an autonomous system (AS) on the Internet, an optical network, a cable television network, a satellite network, a wireless network, an ad hoc network, a telephone network (e.g., the Public Switched Telephone Network (PSTN) or a cellular network), an intranet, or a combination of networks.

The exemplary configuration illustrated in FIG. 1 is provided for simplicity. It should be understood that a typical environment may include more or fewer devices than illustrated in FIG. 1. For example, environment 100 may include a large number (e.g., thousands or more) of UE devices 110 and wireless stations 122, as well as multiple access networks 120, core networks 130 and data networks 150. Environment 100 may also include elements, such as gateways, monitoring devices, network elements/functions, etc. (not shown), that aid in providing data services and routing data in environment 100.

Various functions are described below as being performed by particular components in environment 100. In other implementations, various functions described as being performed by one device may be performed by another device or multiple other devices, and/or various functions described as being performed by multiple devices may be combined and performed by a single device.

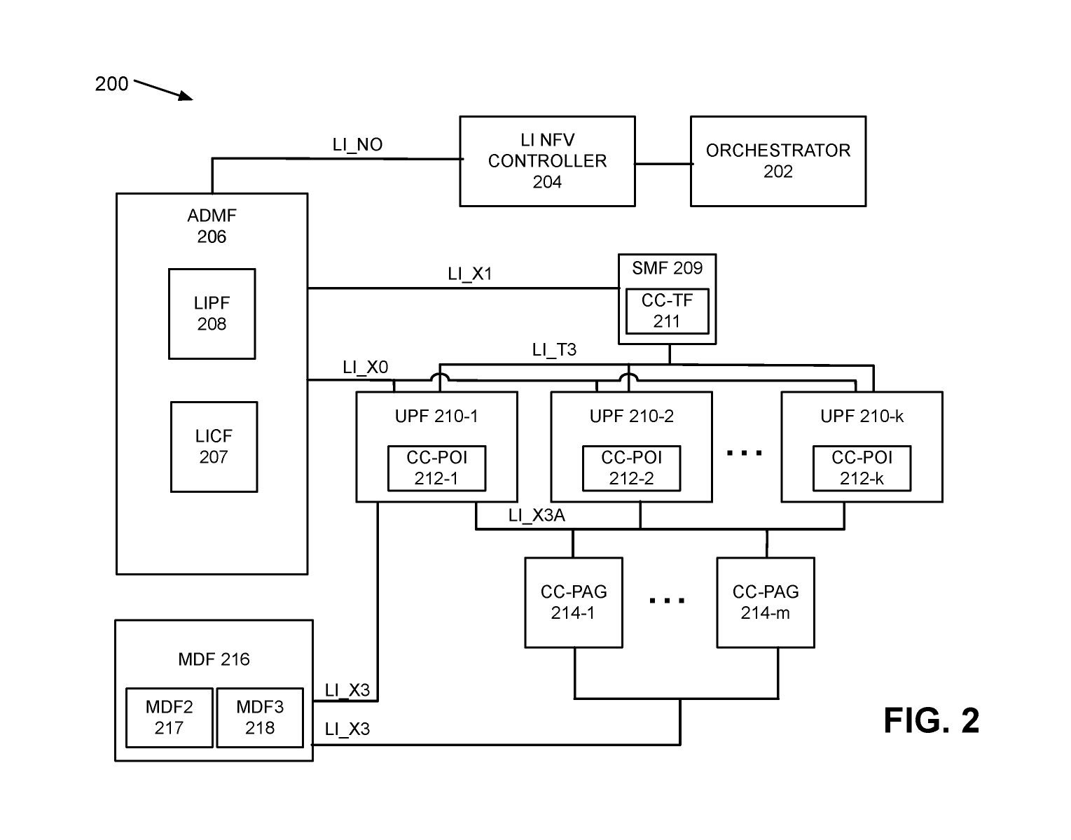

FIG. 2 is a block diagram illustrating a lawful intercept system 200 consistent with implementations described herein. As described briefly above, lawful intercept system 200 may be implemented within core network 130 of a telecommunications service provider. As shown, system 200 includes an orchestrator 202, an LI network function virtualization (NFV) controller 204, an administrative function (ADMF) 206, which may include a Lawful Interception Control Function (LICF) 207 and a Lawful Interception Provisioning Function (LIPF) 208, a session management function device (SMF) 209, (a plurality of user plane function devices (UPFs) 210-1 to 210-k(generally referred to as UPFs 210 and individually as UPF 210), a plurality of content of communication (CC) points of interest (POI) 212-1 to 212-k (generally referred to as CC-POIs 212 and individually as CC-POI 212), a plurality of CC-POI aggregators (CC-PAGs) 214-1 to 214-m (generally referred to as CC-PAGs 214 and individually as CC-PAG 214), and a media and delivery function (MDF) 216.

The number, type, and arrangement of networks illustrated in system 200 are exemplary. Additionally, or alternatively, other networks not illustrated in FIG. 2 may be included in system 200, such as a backhaul/fronthaul network or another type of intermediary network, as well as intercept related information (IRI) elements, such as one or more IRI-POIs or IRI-related MDF devices (e.g., MDF2 devices). As understood herein, IRI relates to information or data associated with communication services involving a target identity, such as communication associated information or data (e.g., unsuccessful communication attempts, communication metadata, etc.), location information, etc. IRI is generally efficiently handled at IRI-POIs and forwarded directly to an associated MDF device (e.g., an MDF2 device) for packaging and ultimate delivery to a law enforcement monitoring function (LEMF) (not shown in FIG. 2).

A network device, a network element, or a network function (referred to herein simply as a network device) may be implemented according to one or multiple network architectures (e.g., a client device, a server device, a peer device, a proxy device, a cloud device, a virtualized function, and/or another type of network architecture (e.g., Software Defined Networking (SDN), virtual, logical, network slicing, etc.)). Additionally, a network device may be implemented according to various computing architectures, such as centralized, distributed, cloud (e.g., elastic, public, private, etc.), edge, fog, and/or another type of computing architecture.

As shown, lawful intercept system 200 includes communication links between various network devices, which may be implemented to include wired, optical, and/or wireless communication links. A communication connection via a communication link may be direct or indirect. For example, an indirect communication connection may involve an intermediary device and/or an intermediary network not illustrated in FIG. 2. A direct communication connection may not involve an intermediary device and/or an intermediary network. The number and the arrangement of communication links illustrated in lawful intercept system 200 are exemplary.

In addition, lawful intercept system 200 may include various planes of communication including, for example, a control plane, a user plane, and a network management plane. Messages communicated in support of an inter-networked lawful intercept service may use at least one of these planes of communication. Additionally, an interface of a network device may be modified (e.g., relative to an interface defined by a standards body, such as Third Generation Partnership Project (3GPP), International Telecommunication Union (ITU), European Telecommunications Standards Institute (ETSI), etc.) or a new interface of the network device may be provided in order to support the communication (e.g., transmission and reception of messages, Information Elements (IE), Attribute Value Pairs (AVPs), etc.) between network devices and the inter-networked lawful intercept service logic, as described herein. According to various exemplary implementations, the interface of the network device may be a service-based interface or a reference point-based interface.

Referring specifically to FIG. 2, orchestrator 202 may include one or more components, such as Operations Support System (OSS), Business Support System (BSS) components and/or other management and orchestration (MANO) components, configured to support and instantiate various network components associated with LI, such as UPFs, POIs, and CC-PAGs, etc. In particular, orchestrator 202 is responsible for controlling the number of virtual network functions (VNFs) and service chains within the network.

In one implementation, OSS/BSS components of orchestrator 202 instructs an NFV MANO of orchestrator 202 to instantiate, scale, or terminate one or more VNFs (e.g., UPFs, POIS, CC-PAGs, etc.). The NFV MANO may also instantiate and terminate VNF sub-components (VNFCs) dynamically without direct input from the OSS/BSS to maintain performance and resilience requirements.

Consistent with implementations described herein, orchestrator 202 may notify LI NFV controller 204 regarding any instantiated UPFs, POIs, and CC-PAGs, including information regarding the relative geographical and/or logical locations of each component. When a VNF about to be instantiated is expected to have LI specific functionalities such as a POI, a PAG, a triggering function (TF), an MDF, etc., LI NFV controller 204 may notify LIPF 208 about those LI specific functionalities within the VNF. LIPF 208 may then forward that notification to a Lawful Intercept Control Function (LICF) that is generally included with ADMF 206, which in turn, validates/verifies/authorizes the particular VNF over an LI_X0 interface.

As generally described above, ADMF 206 may provide the administrative and management functions for the LI capability. In one embodiment, such functions may include the overall responsibility for the provisioning/activating, modifying, and de-activating/de-provisioning various LI-related components, such as POIs, TFs, and PAGs, which activate interception of communications content, and MDFs (e.g., MDF 216) which receives the relevant intercepted content. As described above, ADMF 206 may include LICF 207 and LIPF 208.

LICF 207 is a network function configured to receive lawful warrant information from a LEA, derive intercept-related information from the warrant information, and provide such intercept-related information to LIPF 208 for use in provisioning the various LI-related network functions described herein.

LIPF 208 is a network function configured to function as a secure proxy used by LICF 207 to provision and communicate with various LI-related network functions (e.g., POIs, TFs, PAGs, MDFs, or other infrastructure required to operate LI within the provider network. Accordingly, LIPF 208 generally does not store target information, but rather routes messages to and from LICF 207 via an LI_X1 interface. In scenarios in which ADMF 206 takes an active role in POI triggering, LIPF 208 may receive triggering information (e.g. from an IRI-TF) and forward the triggering information to the appropriate POI.

In some implementations, LIPF 208 may be responsible for identifying changes to provisioned network functions. In such implementations, LIPF 208 may notify LICF 207 regarding changes affecting the number of active network functions or other information which LICF 207 requires to maintain a master list of provisioned LI-related network functions.

SMF 209 includes a network device that may operate and provide various session management functions, such as UE IP address allocation and management, selection and control of a UPF 210, traffic steering, and control part of policy enforcement and QoS at UPFs 210, etc. Furthermore, SMF 209 includes logic that supports lawful interception, such as IRI-POI logic, CC-triggering function logic (CC-TF) 211, etc.

When interception of CC is required, SMF 209 (i.e., its CC-TF 211) may send a trigger to one or more UPFs 210 (e.g., to CC-POIs 212 in UPFs 210) over a LI_T3 interface. The trigger includes user plane packet detection rules, target identifying information, correlation information, and the network address for the MDF3 which receives any resulting CC data.

Each of UPFs 210 may include a network device that may operate and provide various user plane-related network functions, such as packet routing and forwarding, packet inspection, policy rule enforcement on the user plane, traffic usage reporting, QoS handling on the user plane, etc. Consistent with implementations described herein, each UPF 210, among other non-lawful intercept functions, may be configured to support lawful interception and may include a CC-POI 212. In some implementations, one or more CC-POIs 212 may be instantiated within a network function separate from a UPF 210. In any event, each CC-POI 212 is configured to intercept data transmitted to or from a UE 110 that traverses the network function associated with the particular CC-POI 212. In one embodiment, each CC-POI 212 can intercept data transmitted over a data plane.

As briefly described above, to support lawful interception, UPFs 210 (e.g., CC-POIs 212) may be configured to receive triggers from SMF 209 (e.g., from the CC-TF 211 in SMF 209) via the LI_T3 interface that indicates the identity of the target, the various detection rules, correlation information, and the network address for the MDF3 which receives any intercepted data.

Depending on the scope of the interception and the nature of the data being intercepted, data intercepted at CC-POIs 212 may be captured at a rate which may not be efficiently transmitted to MDF 216 in real time. To accommodate forwarding of such data, data intercepted at a plurality of CC-POIs 212 may be aggregated or collected at one or more CC-PAGs 214 prior to transmission to MDF 216. In particular, consistent with implementations described herein, CC-PAGs 214 may be deployed geographically or logically closer to the UPFs 210, to reduce the impact of latencies, packet drops, and buffering on UPFs 210 for lawful interception of high-speed user plane traffic. As shown, CC-POIs 212 may transmit CC (e.g., on a per flow basis) to a respective CC-PAG 214 via an LI_X3A interface.

Consistent with implementations described herein, each CC-PAG 214 includes a network function that can be deployed in networks that need aggregation of CC from a potentially large number of different CC-POIs 212 towards MDF 216 (e.g., MDF3 218). During provisioning, the ADMF 204 provides an address of a corresponding MDF (e.g., MDF3 218) to each CC-PAG 214. In some embodiments, the CC-PAG 214 may forward received CC data without modification to the MDF3 218. Although only two CC-PAGs 214 are illustrated, more (or fewer) CC-PAG devices or network functions may be provisioned.

During provisioning of a CC-PAG 214, LIPF 208 may be configured to provide the address(es) of the relevant CC-PAG(s) 214 to each associated CC-POI 212 in UPFs 210, and similarly to provide an appropriate MDF (e.g., MDF3) address to CC-PAG 214 via the LI_X0 interface. Consistent with implementations described herein, during provisioning of one or more CC-PAGs 214, LIPF 208 may provide selection criterion regarding the one or more CC-PAGs 214. Such selection criterion may include, for example, specific services, traffic types, data networks, etc. associated with a particular CC-PAGs 214. For example, all messaging traffic may be routed to CC-PAG 214-1, while general web-browser traffic may be routed to a CC-PAG 214-2, etc. In one implementation, such selection criteria may be provided as CC-TF 211 in SMF 209 may be configured to include the network address for a relevant CC-PAG 214 in lieu of the MDF3 address.

Upon provisioning and selection at the time of interception, each CC-PAG 214 receives intercepted CC data from one or more CC-POIs 212. For example, as shown in FIG. 2, CC-PAG 214-1 receives a first portion of CC data from CC-POI 212-1 in UPF 210-1, while CC-PAG 214-2 receives a second portion of CC data from CC-POI 212-1 in UPF 210-1 as well as a first portion of CC data from CC-POI 212-2 in UPF 210-2. Similarly, CC-PAG 214-2 receives a second portion of CC data from CC-POI 212-2 in UPF 210-2 as well as an entirety of the CC data from CC-POI 212-3 in UPF 210-3. It should be understood that the exemplary distribution and association of CC-POIs 212 and CC-PAGs 214 shown in FIG. 2 are illustrative of the flexibility of system 200. In practice, any number and arrangement of CC-POIs 212 and CC-PAGs 214 may be implemented, in a manner consistent with embodiments described herein.

MDF 216 includes a logical function configured to deliver LI data to a LEMF. As shown in FIG. 2, MDF 216 includes MDF2 217 and MDF3 218. MDF2 217 and MDF3 218 are provisioned by the LIPF 208 with the intercept information necessary to deliver the IRI and/or CC to the one or more LEMFs. MDF2 217 receives intercepted IRI data (e.g., from SMF 209) and sends it to one or more LEMFs, while MDF3 218 receives intercepted CC (e.g., from CC-POIs 212 and/or CC-PAGs 214) and sends it to one or more LEMFs.

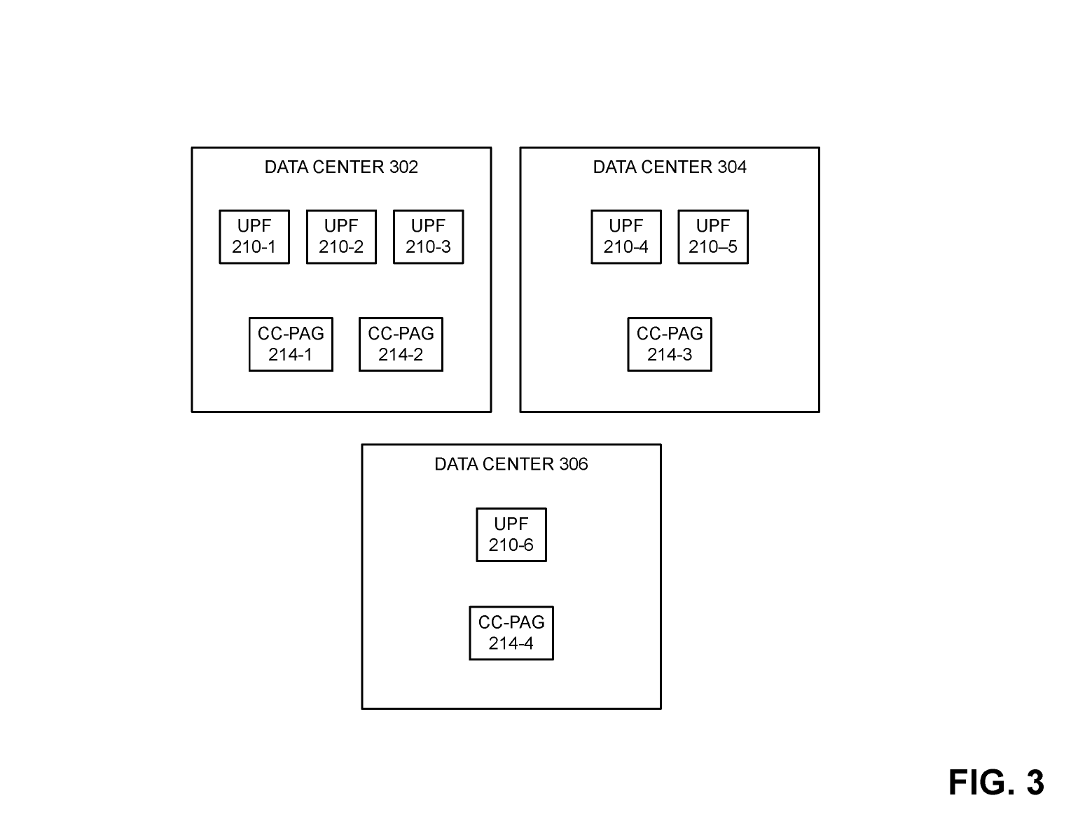

FIG. 3 is a block diagram illustrating an exemplary environment consistent with implementations described herein. FIG. 3 depicts a plurality of data centers in an telecommunications network 300 consistent with exemplary embodiments. As shown, telecommunications network 300 may include a plurality of data centers including data center 302, data center 304, and data center 306. The specific number of data centers is not limiting, and any number of data centers can be used to implement the telecommunications network. Data centers 302-306 can be geographically dispersed regionally, or globally, and no limit is placed on the specific location of a given data center.

Consistent with implementations described herein, a given data center 302-306 may include one or more UPFs 210 and CC-PAGs 214 as well as other network functions. For example, data center 302 includes three UPFs 210-1, 201-2, and 210-3; data center 304 includes two UPFs 210-4 and 210-5; and data center 306 includes one UPF 210-6. Similarly, data center 302 includes two CC-PAGs 214-1 and 214-2; data center 304 includes one CC-PAG 214-3; and data center 306 includes one CC-PAG 214-4.

UPFs 210 and CC-PAGs 214 can communicate with one another within a given data center instance. In some embodiments, UPFs 210 and CC-PAGs 214 can communicate with UPF and CC-PAGs in other data center instances. As discussed above with reference to FIG. 2, a given UPF 210 may be associated with one or more POIs (e.g., CC-POIs 212) and may communicate with CC-PAGs 214 within the data center or between different data centers. Consistent with implementations described herein, the UPFs 210 in each data center 302-306 may be associated with different CC-PAG selection criteria based upon, for example, the specific performance characteristics or data types associated with each respective data center.

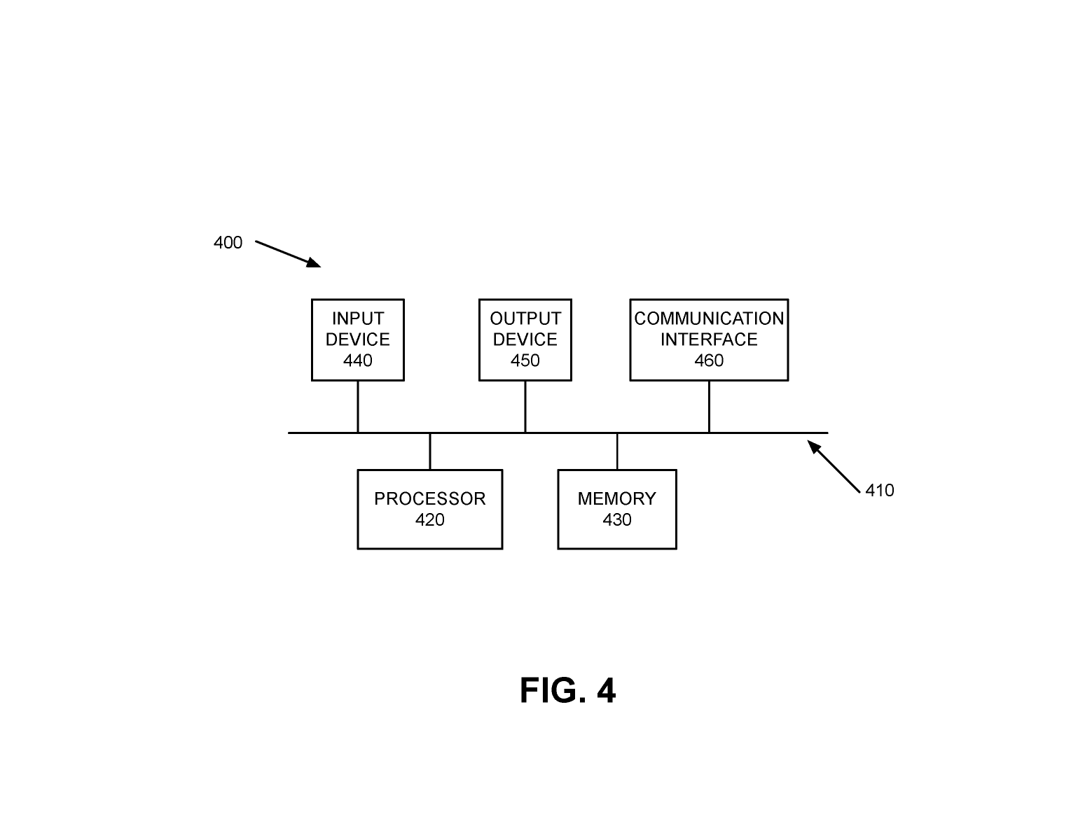

FIG. 4 illustrates an exemplary configuration of a device 400. One or more devices 400 may correspond to or be included in devices in environment 100, such as UE device 110, wireless station 122, network devices 140 (e.g., ADMF 206, SMF, 209, UPFs 210, CC-PAGs 214,), and other devices included in environment 100. Referring to FIG. 4, device 400 may include bus 410, processor 420, memory 430, input device 440, output device 450 and communication interface 460. The exemplary configuration illustrated in FIG. 4 is provided for simplicity. It should be understood that device 400 may include more or fewer components than illustrated in FIG. 4.

Processor 420 may include one or more processors, microprocessors, or processing logic that may interpret and execute instructions. Memory 430 may include a random access memory (RAM) or another type of dynamic storage device that may store information and instructions for execution by processor 420. Memory 430 may also include a read only memory (ROM) device or another type of static storage device that may store static information and instructions for use by processor 420. Memory 430 may further include a solid state drive (SSD). Memory 430 may also include a magnetic and/or optical recording medium (e.g., a hard disk) and its corresponding drive.

Input device 440 may include a mechanism that permits a user to input information, such as a keypad, a keyboard, a mouse, a pen, a microphone, a touch screen, voice recognition and/or biometric mechanisms, etc. Output device 450 may include a mechanism that outputs information to the user, including a display (e.g., a liquid crystal display (LCD), a light emitting diode (LED) display), a speaker, etc. In some implementations, device 400 may include a touch screen display that may act as both an input device 440 and an output device 450.

Communication interface 460 may include one or more transceivers that device 400 uses to communicate with other devices via wired, wireless or optical mechanisms. For example, communication interface 460 may include one or more RF transmitters, receivers and/or transceivers and one or more antennas for transmitting and receiving RF data. Communication interface 460 may also include a modem or an Ethernet interface to a LAN or other mechanisms for communicating with elements in a network.

In an exemplary implementation, device 400 performs operations in response to processor 420 executing sequences of instructions contained in a computer-readable medium, such as memory 430. A computer-readable medium may be defined as a physical or logical memory device. The software instructions may be read into memory 430 from another computer-readable medium (e.g., a hard disk drive (HDD), SSD, etc.), or from another device via communication interface 460. Alternatively, hard-wired circuitry may be used in place of or in combination with software instructions to implement processes consistent with the implementations described herein. Thus, implementations described herein are not limited to any specific combination of hardware circuitry and software.

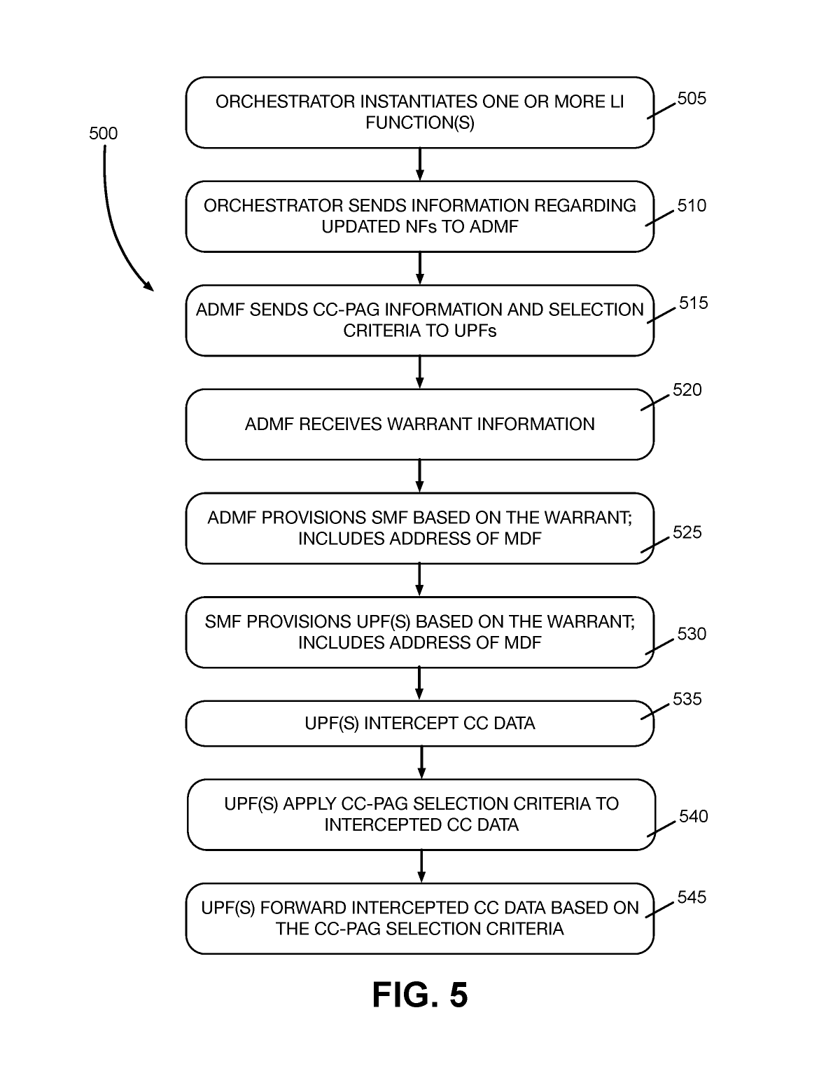

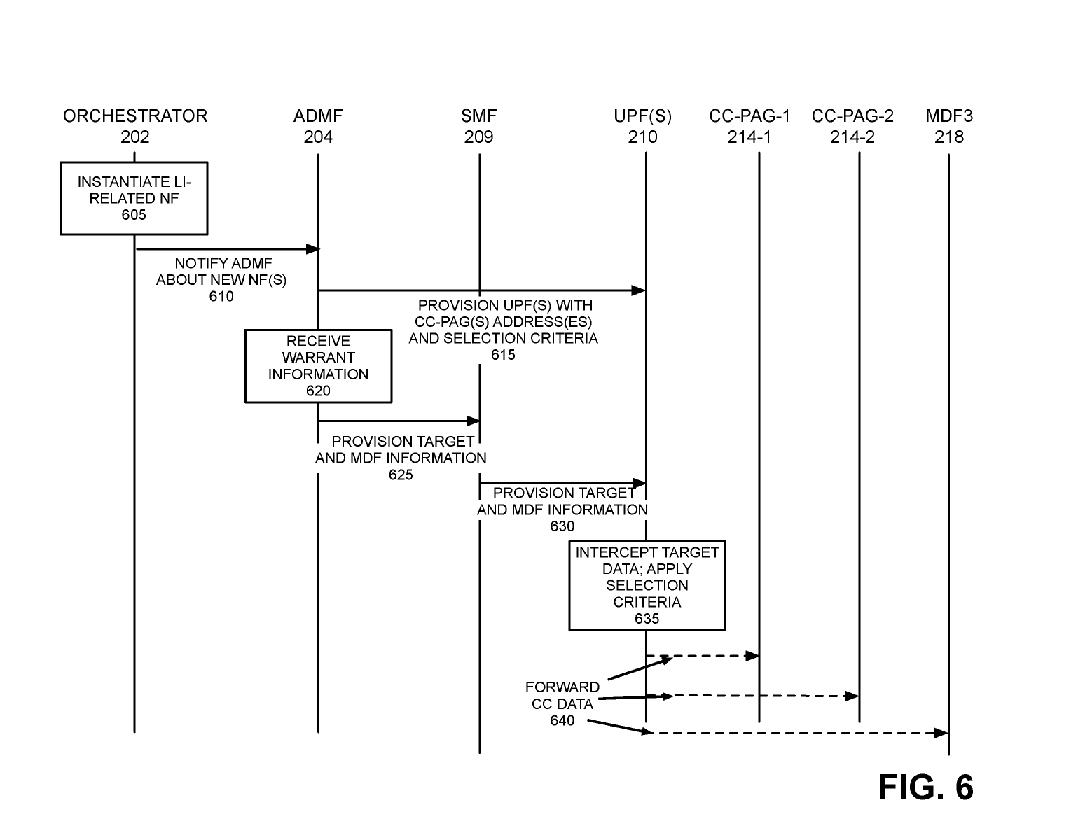

FIG. 5 is a flow diagram illustrating an exemplary process 500 associated with provisioning or updating a lawful intercept system consistent with implementations described herein. FIG. 6 is a call flow diagram illustrating exemplary signal flows associated with the processing of FIG. 5. Processing may begin with orchestrator 202 creating an instance of one or more LI-related components, such as a UPF 210 and/or a CC-PAG 214 (FIG. 5, block 505; FIG. 6, 605). For example, NFV MANO of orchestrator 202, upon receipt of instructions by an OSS/BSS component, may instantiate, scale, or terminate one or more LI-related network functions.

Orchestrator 202 may then send information regarding any updated NFs to ADMF 206 (FIG. 5, block 510; FIG. 6, 620). For example, orchestrator 202 may notify LI NFV controller 204 regarding any instantiated UPFs, POIs, and CC-PAGs. The notification may include information regarding the relative geographical and/or logical locations of each component. LI NFV controller 204 may then notify LIPF 208 in ADMF 206 over an LI_NO interface about those LI-specific network functions. LIPF 208 may then forward that notification to LICF 207 (also located in ADMF 206). As briefly described above, LICF 207 validates/verifies/authorizes the new NFs.

ADMF 206 then transmits information and related selection criteria regarding CC-PAGs 214 to UPFs 210 (FIG. 5, block 515; FIG. 6, 625). For example, LIPF 108 may provide the network address(es) of the relevant CC-PAGs 214 to each associated CC-POI 212 in UPFs 210 via a LI_X0 interface. Consistent with implementations described herein, during provisioning of one or more CC-PAGs 214, LIPF 208 may also provide selection criterion regarding the one or more CC-PAGs 214. Such selection criterion may include, for example, specific services, traffic types, data networks, etc. associated with a particular CC-PAGs 214.

Next, ADMF 206 may receive a warrant for a particular target (FIG. 5; block 520; FIG. 6 620). For example, LICF 207 may receive and validate a warrant or information request from a law enforcement entity 150. In response, LICF 207 may transmit intercept-related identification information regarding the particular target to LIPF 208. In response to the warrant for the target, ADMF 206 may provision the intercept-related network elements based information derived from the received warrant (FIG. 5, block 525; FIG. 6, 635). For example, among other elements, LIPF 208 may provision CC-TF 211 in SMF 209 via an LI_X1 interface. Among other target information (e.g., target identification information, types of data to be intercepted, etc.), LIPF 208 may provision the network address of a particular MDF associated with the target to SMF 209 over the LI_X1 interface.

Next, SMF 209 provisions UPFs 210 with information regarding the target and related data interception (FIG. 5, block 530; FIG. 6, 630). For example, CC-TF 211 in SMF 209 may pass target and data interception information, such as target identification information, interception rules, the network address of the associated MDF (e.g., MDF3 218), and correlation information to CC-POIs 212 in UPFs 210 over a LI_T3 interface. In some embodiments, the interception rules can comprise any rules that define when and how the UPF should intercept data to or from the identified target. In some embodiments, the correlation information can comprise any information used to handle handover interface correlation.

Based on the received target and data interception information received in block 530, UPFs 210 may intercept target CC data (FIG. 5, block 535; FIGS. 6, 635). Upon receipt of the target data, UPFs 210 may apply the CC-PAG selection criteria provisioned in block 515 to determine a destination for the intercepted CC data (FIG. 5, block 540;FIG. 6, 635). For example, depending on specific capabilities of particular UPFs 210 or likely congestion points, etc., UPFs 210 may identify a particular CC-PAGs 214 and/or MDF3 218 to which to forward the intercepted CC data. UPFs 210 may then forward the intercepted CC data to the identified destination (FIG. 5, block 545. As shown at alternative elements 640 (FIG. 6) destinations may include any of the available CC-PAGs 214 (e.g., CC-PAG 214-1 or CC-PAG 214-2) or MDF3 218 depending on the results of blocks 540/635.

As set forth in this description and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration, but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while series of blocks and/or signals have been described with regard to the processes illustrated in FIGS. 5 and 6, the order of the blocks (or signals) may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware (e.g., processor 410, etc.), or a combination of hardware and software (e.g., software 420).

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 410) of a device. A non-transitory storage medium includes one or more of the storage mediums described in relation to memory/storage 415. The non-transitory computer-readable storage medium may be implemented in a centralized, distributed, or logical division that may include a single physical memory device or multiple physical memory devices spread across one or multiple network devices.

To the extent the aforementioned embodiments collect, store or employ personal information of individuals, it should be understood that such information shall be collected, stored, and used in accordance with all applicable laws concerning protection of personal information. Additionally, the collection, storage and use of such information can be subject to consent of the individual to such activity, for example, through well known “opt-in” or “opt-out” processes as can be appropriate for the situation and type of information. Collection, storage and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such. All structural and functional equivalents to the elements of the various aspects set forth in this disclosure that are known or later come to be known are expressly incorporated herein by reference and are intended to be encompassed by the claims.

What is claimed:

1. A method, comprising:
transmitting information regarding one or more user plane functions (UPFs) or content of communication (CC) point of intercept (POI) aggregators (CC-PAGs) that have been updated or instantiated on a telecommunications network to an administrative function of a lawful intercept system in the telecommunications network; and
automatically provisioning, in response to the transmitting, each UPF associated with the administrative function regarding identities of available CC-PAGs and selection criteria for determining when to forward intercepted CC to particular ones of the available CC-PAGs.

2. The method of claim 1, wherein the administrative function comprises a lawful interception provision function (LIPF), and
wherein the transmitting is performed via a LI_NO interface in the lawful intercept system.

3. The method of claim 1, wherein the identities of the available CC-PAGs comprise network addresses of the available CC-PAGs, and
wherein the selection criteria identify one or more of specific services, traffic types, or data network names associated with each of the available CC-PAGs.

4. The method of claim 1, further comprising:
receiving, by the administrative function, a lawful intercept request;
forwarding information regarding the lawful intercept request to each UPF associated with the administrative function;
intercepting, by a particular one of the UPFs in the telecommunications network, CC data based on the lawful intercept request; and
applying, by the particular one of the UPFs, the selection criteria to identify a destination of the intercepted CC data from among the available CC-PAGs or a mediation and delivery function (MDF).

5. The method of claim 4, wherein forwarding information regarding the lawful intercept request to each UPF associated with the administrative function further comprises:
provisioning, by the administrative function, a session management function (SMF) regarding a target identified in the lawful intercept request and a network address of the MDF for receiving the intercepted CC data; and
provisioning, by the SMF, each UPF regarding the target the network address of the MDF for receiving the intercepted CC data.

6. The method of claim 5,
wherein provisioning the SMF is performed via a LI_X1 interface; and
wherein the provisioning each UPF is performed via a LI_T3 interface.

7. The method of claim 4,
wherein the lawful intercept request comprises a warrant received from a law enforcement entity.

8. The method of claim 1, further comprising:
forwarding the intercepted CC data to the identified destination.

9. A system, comprising:
at least one device configured to:
transmit information regarding one or more user plane functions (UPFs) or content of communication (CC) point of intercept (POI) aggregators (CC-PAGs) that have been updated or instantiated on a telecommunications network to an administrative function of a lawful intercept system in the telecommunications network; and
automatically provision, in response to the transmitting, each UPF associated with the administrative function regarding identities of available CC-PAGs and selection criteria for determining when to forward intercepted CC to particular ones of the available CC-PAGs.

10. The system of claim 9, wherein the administrative function comprises a lawful interception provision function (LIPF), and
wherein the information is transmitted to LIPF via a LI_NO interface in the lawful intercept system.

11. The system of claim 9, wherein the identities of the available CC-PAGs comprise network addresses of the available CC-PAGs, and
wherein the selection criteria identify one or more of specific services, traffic types, or data network names associated with each of the available CC-PAGs.

12. The system of claim 9,
wherein the administrative function is further configured to:
receive a lawful intercept request;
forward information regarding the lawful intercept request to each UPF associated with the administrative function;
wherein a particular one of the UPFs in the telecommunications network is configured to:
intercept CC data based on the lawful intercept request; and
apply the selection criteria to identify a destination of the intercepted CC data from among the available CC-PAGs or a mediation and delivery function (MDF).

13. The system of claim 12,
wherein the administrative function is further configured to provision a session management function (SMF) regarding a target identified in the lawful intercept request and a network address of the MDF for receiving the intercepted CC data; and
wherein the SMF is configured to provision each UPF regarding the target the network address of the MDF for receiving the intercepted CC data.

14. The system of claim 13,
wherein provisioning the SMF is performed via a LI_X1 interface; and
wherein the provisioning each UPF is performed via a LI_T3 interface.

15. The system of claim 12,
wherein the lawful intercept request comprises a warrant received from a law enforcement entity.

16. The system of claim 9, wherein the particular one of the UPFs in the telecommunications network is further configured to:
forward the intercepted CC data to the identified destination.

17. A non-transitory computer-readable medium having stored thereon sequences of instructions which, when executed by at least one processor, cause the at least one processor to:
transmit information regarding one or more user plane functions (UPFs) or content of communication (CC) point of intercept (POI) aggregators (CC-PAGs) that have been updated or instantiated on a telecommunications network to an administrative function of a lawful intercept system in the telecommunications network; and
automatically provision, in response to the transmitting and by the administrative function, each UPF associated with the administrative function regarding identities of available CC-PAGs and selection criteria for determining when to forward intercepted CC to particular ones of the available CC-PAGs.

18. The non-transitory computer-readable medium of claim 17, wherein the identities of the available CC-PAGs comprise network addresses of the available CC-PAGs, and
wherein the selection criteria identify one or more of specific services, traffic types, or data network names associated with each of the available CC-PAGs.

19. The non-transitory computer-readable medium of claim 17, wherein the instructions further cause the at least one processor to:
receive, by the administrative function, a lawful intercept request;
forward information regarding the lawful intercept request to each UPF associated with the administrative function;
intercept, by a particular one of the UPFs in the telecommunications network, CC data based on the lawful intercept request; and
apply, by the particular one of the UPFs, the selection criteria to identify a destination of the intercepted CC data from among the available CC-PAGs or a mediation and delivery function (MDF).

20. The non-transitory computer-readable medium of claim 17, wherein the instructions further cause the at least one processor to:
forward the intercepted CC data to the identified destination.
